(19) United States
(12) Patent Application Publication
(10) Pub. No.: US 2008/0195726 A1
(43) Pub. Date: Aug. 14, 2008

(54) Dynamical Reconfiguration of Distributed Composite State Machines

(76) Inventors: Geir Melby, Heggedal (NO); Knut Eilif Husa, Sande i Vestfold (NO)

Correspondence Address: ERICSSON INC., 6300 LEGACY DRIVE, M/S EVR 1-C-11, PLANO, TX, 75024, US

(21) Appl. No.: 11/574,287

(22) PCT Filed: Apr. 21, 2005
(86) PCT No.: PCT/NO05/00134

§ 371 Date: Nov. 6, 2007

(30) Foreign Application Priority Data
Aug. 25, 2004 (NO) 20043557

(51) Int. Cl. G06F 15/177; H04L 29/06

(52) U.S. Cl. 709/221

(57) ABSTRACT

The present invention discloses a method for dynamically deployment and reconfiguration of services such as peer to peer type of services using a protocol suite running on a generic distributed middleware platform, such as ActorFrame where said method comprise the steps of: detecting changes in the configuration specification for one or more actors and responding to changes in the configuration specification for the actors with a response sent to affected actors so as to take needed actions according to the changes, and dynamically and preferably in real time reconfigure the affected actors with reconfigurations as follows: adding one or more new actors and changing a number of maximum and minimum number of allowed actors and reconfiguring existing connections between actors. Further the present invention discloses a corresponding protocol suite for dynamically deployment and reconfiguration of services.

### FIELD OF THE INVENTION

The present invention relates a method and system disclosing how to implement how changes in specifications of compositions of actors can be reflected in a running system.

### BACKGROUND OF THE INVENTION

From the prior art it is known that Telefonaktiebolaget L. M. Ericsson has developed a prototype of a Service Execution Framework called ServiceFrame [1]. The services will be deployed in networks where current Telecommunication and Internet has merged into an open service oriented network. The services are modelled using UML 2.0 concepts for concurrent state machines communicating asynchronously through message passing.

Two patent applications the first PCT/NO2004/000142-disclosing aggregation of non blocking state machines on Enterprise Java Bean Platform and the other PCT/NO2004/000143 disclosing non blocking persistent state machines on Enterprise Java Bean Platform both issued by Telefonaktiebolaget L. M. Ericsson is incorporated herein by reference.

### Serviceframe—a Service Creation and Execution Environment

ServiceFrame is an application server in the service network. It provides functionality for communication with users connected through different types of terminals such as phones, PC's or PDA's FIG. 1. It also provides access to network resources through the OSA API, which enable services to set up phone calls between users.

ServiceFrame itself provides architectural support for service creation, service deployment and service execution. Services are realized by ServiceFrame applications that are defined by specializing and instantiating framework classes. In addition it has mechanisms that support incremental development and deployment of services.

ServiceFrame is layered on top of ActorFrame and JavaFrame as shown in FIG. 2. ActorFrame is a generic application framework that supports the concept of actors and roles. With ActorFrame actors play roles and involve other actors to play other roles. Actors may contain other actors. JavaFrame is both an execution environment and a library of classes used to implement concurrent state machines and asynchronous communication between state machines. JavaFrame is implemented using J2EE technology.

ActorFrame uses the well-known metaphor that “actors play roles”. Actors are objects that play different roles. Hence, a service may be defined in terms of collaborating service roles where a service role is the part an actor plays in a service. Models that use the ActorFrame concepts are called ActorFrame models.

Actor is the core concept of ActorFrame. An actor, illustrated in FIG. 3, is an object having a state machine and an optional inner structure of actors. Some of these inner actors are static, having the same lifetime as the enclosing actor. The state machine of an actor will behave according to the generic actor behaviour that is common to all actors. If the actor shall play several roles, this is accomplished by creating several inner actors each playing one of the desired roles.

Communication between an actor and its environment takes place via an Inport and Outports.

### Package Overview of ActorFrame

ActorFrame is implemented in Java in a package called actorframe. The main classes are as follows refer to FIG. 4:
ActorSM that defines “housekeeping” methods used in the transaction of ActorCS. E.g. Initialisation, creation of parts, release of associations. It also defines utility methods intended for the developer like sendRoleRelease and sendRoleRequest.
ActorCS that defines the behaviours of the Actor. The various behaviours of the Actor will be described in this chapter.
ActorContext that is a special class that holds the associations to other Actors.
ActorBean that is a class that defines the data structure of the entity bean.
Actor that extends the StateData class contains get and set methods for the data elements of the entity bean.
ActorHome that extends the StateDataHome interface with methods for creation of entity beans and find entity methods.
PartSpec that defines a part of the Actor.
PortSpec that defines a port and connection of the Actor.
   Problems with Existing Solutions

The existing service platforms do not provide support for dynamic reconfiguration of executing services without stopping the service(s) and this in turn affects the availability of the services.

Also, the existing protocols in ActorFrame does not support the dynamically deployment and reconfiguration of services implemented as actors. The actors have support for creation and deletion of actors, but this is not done as part of the configuration of the system. It is more as a part of the service it self. So current versions lacks mechanism for specifying the configuration of the actors system, which automatically cause changes of the running system.

In order to configure the structure (assuming that services consist of many components) of running services all influenced components of the services must be updated. This is a complex task due to the dependencies among the components. Hence the services need to be deployed and reconfigured dynamically to meet the demands from the market.

There exist no public available known solutions to this problem.

### SUMMARY OF THE INVENTION

As to overcome the problems as described above the present invention discloses method for dynamically deployment and reconfiguration of services such as peer to peer type of services using a protocol suite running on a generic distributed middleware platform, such as ActorFrame where said method comprise the steps of:
detecting changes in the configuration specification for one or more actors and responding to changes in the configuration specification for the actors with a response sent to affected actors so as to take needed actions according to the changes, and
dynamically and preferably in real time reconfigure the affected actors with reconfigurations as follows:
adding one or more new actors and changing a number of maximum and minimum number of allowed actors and
reconfiguring existing connections between actors

Further the present invention discloses a corresponding protocol suite for dynamically deployment and reconfiguration of services such as peer to peer type of services running on a generic distributed middleware platform, such as ActorFrame where the protocol suite is adapted to:
detect changes in the configuration specification for one or more actors and to respond to changes in the configuration specification for the actors with a response sent to affected actors so as to take needed actions such as add new instances of actors according to the changes, and

the protocol suite is further adapted to dynamically and preferably in real time to reconfigure the affected actors with reconfigurations as follows:
to add new instances of actors and to change number of maximum and minimum number of allowed actors instances, and
to remove or reconfigure existing connections between actors thereby allowing changes of structures (such as) as versions of one or more actor changes in order to add new connections between actors to adapt to new actors.

### BRIEF DESCRIPTIONS OF THE DRAWINGS

FIG. 1 shows a ServiceFrame—Service Execution Framework,

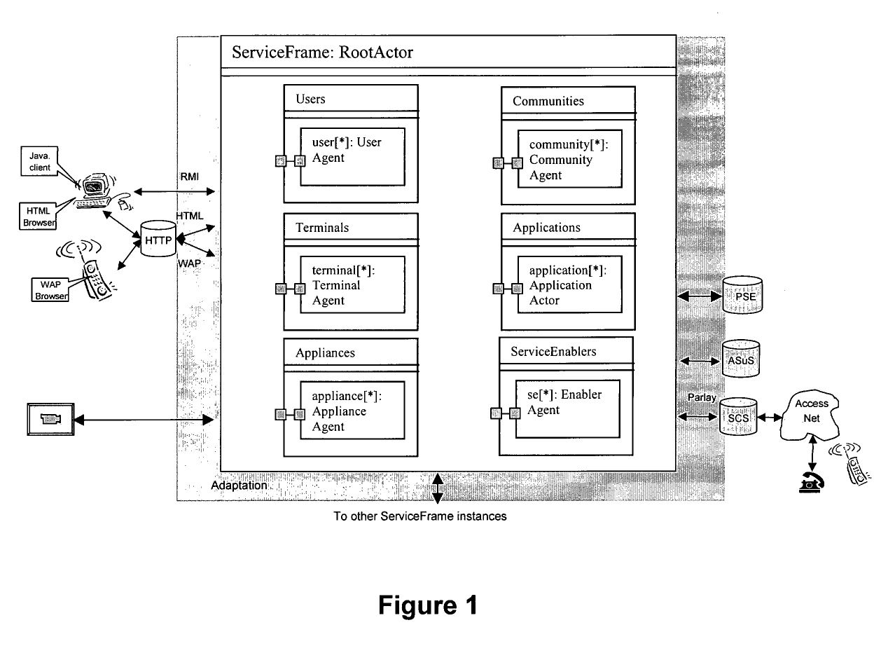

FIG. 2 shows ServiceFrame layers

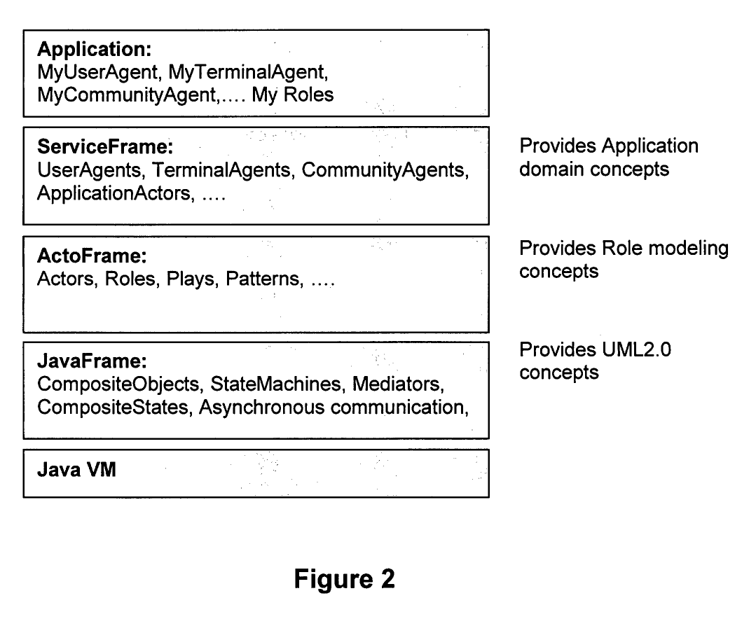

FIG. 3 shows Class Actor

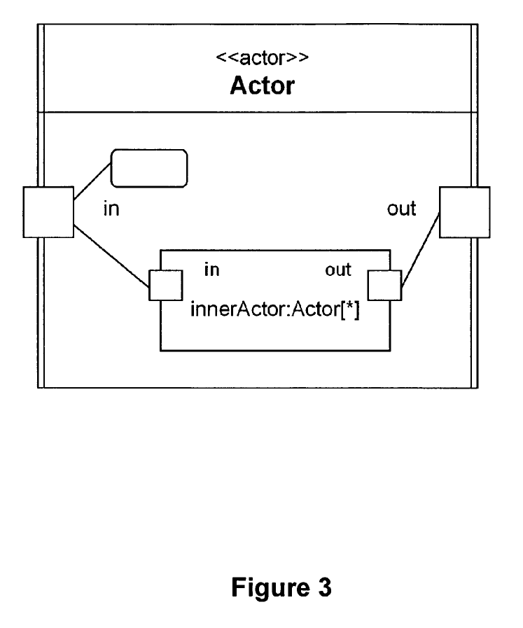

FIG. 4 shows ActorFrame Classes

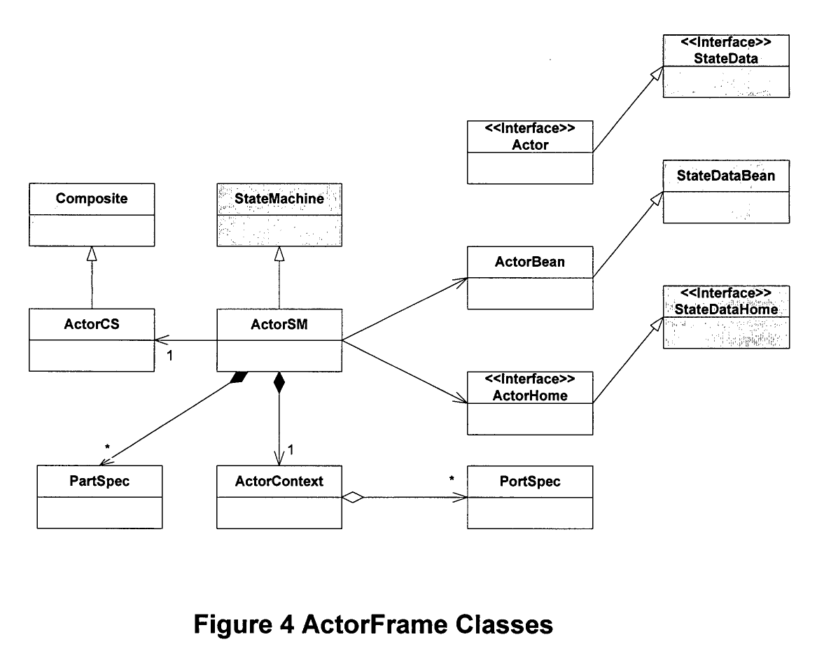

FIG. 5 shows the RoleRequest protocol

FIG. 6 shows Multiple roles and actors

FIG. 7 shows A simple service.

FIG. 8 shows Configuration of BetaActor

FIG. 9 BetaActor xml configuration file

FIG. 10 Communication Diagram of RoleRequest pattern

FIG. 11 RoleRequest protocol

FIG. 12 port setup process

FIG. 13 Role create process

FIG. 14 Inquired Role view of Actor State Machine

FIG. 15 Requested Role view of Actor state machine

FIG. 16 Initial role view of Actor state machine

FIG. 17 Role update sequence

FIG. 18 Update role view of Actor State machine

FIG. 19 Updated part view of Actor State machine

FIG. 20 Role Release sequence

FIG. 21 Role Release view of Actor state machine

FIG. 22 Role Remove interaction

FIG. 23 Role Remove view of Actor state machine

### DETAILED DESCRIPTION

To make the present invention readily understandable reference will be made to the accompanying drawings, further to point out the essence of the present invention the basic concepts will be outlined in the following section

### Basic Concept

The invention consists of new protocols for ActorFrame that provide solutions for
detecting changes in the configuration specification for actors and notifying affected actors to take needed actions according to the changes.
dynamic reconfiguration of the affected actors such as
   adding new instances of actors and changing number of maximum and minimum number of allowed actors instances
   removing or reconfiguration of existing connections between actors to allow changes of structures as changing of versions of an actor
   adding new connections between actors to adapt new actors.

These additions to the current version of ActorFrame provide the basic solution to the problem of dynamically changing of services deployed on the ServiceFrame execution framework. It may be also adapted to other service platforms following the approach described in this invention.

The invention consists of a set of ActorFrame protocols and state machines used to implement the actor configuration in request. The Actor configuration specifies the structures of actors and the connections among them. In the invention an XML file format is selected for describing the Actor configuration to be deployed.

In this chapter we will first give a brief overview of the generic behaviour of Actors and the usage of the protocols. Further, we will introduce the description format of the Actor configuration files. Eventually we describe the state machine and signal sequence diagrams of the ActorFrame protocols in a detailed manner.

This section contains subsections describing the following matters:

A first section (Actor Protocols) giving an overview of Actor protocols and its usage

A second section (Actor Configuration) giving a description of Actor configuration files

A third section (Messages) disclosing a description of the messages involved in the protocols

A fourth section (Role Creation) disclosing protocols and state machines related to the Actor creation process

A fifth section (Role Update) disclosing protocols and state machines related to the Actor update process

A sixth section (Role Release) disclosing protocols and state machines related to the Actor release process

The seventh section (Role Remove) disclosing protocols and state machines related to the Actor removal process

### Actor Protocols

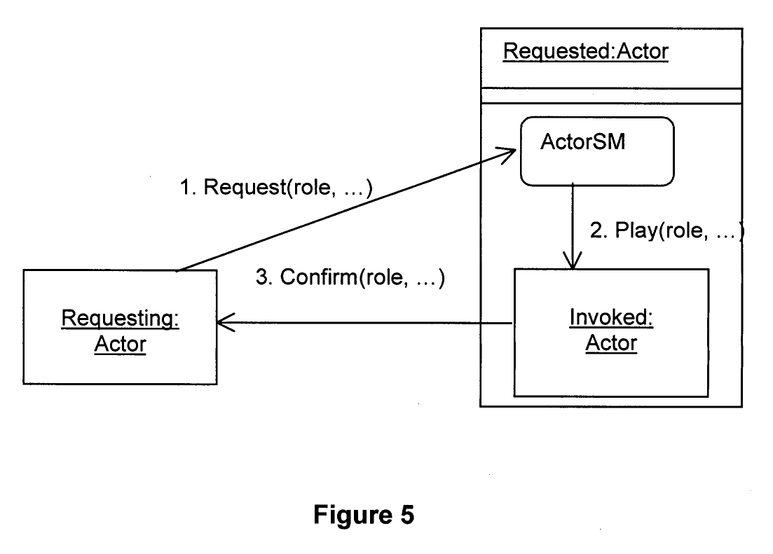

Actors have protocols for role requests and role releases used during configuration. New roles can be created dynamically and initiated on requests. The intention is that an actor can request another actor to initiate new roles (actors) to do a requested service. FIG. 5 describes how an actor will either deny the request or invoke an actor to play the requested role or an acceptable alternative role.

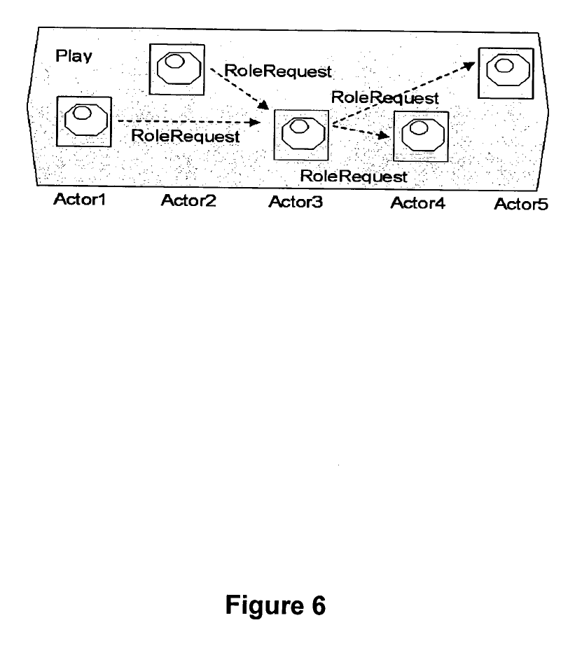

As shown in FIG. 6 an actor may request several other actors and several other actors may request one actor. All actors are running in parallel. An actor may play several roles in parallel. If a requested role is released from all requestors, the requested actor will delete the role. If a requested actor or role is defined but it does not exist, it will be created, if it is allowed to be involved

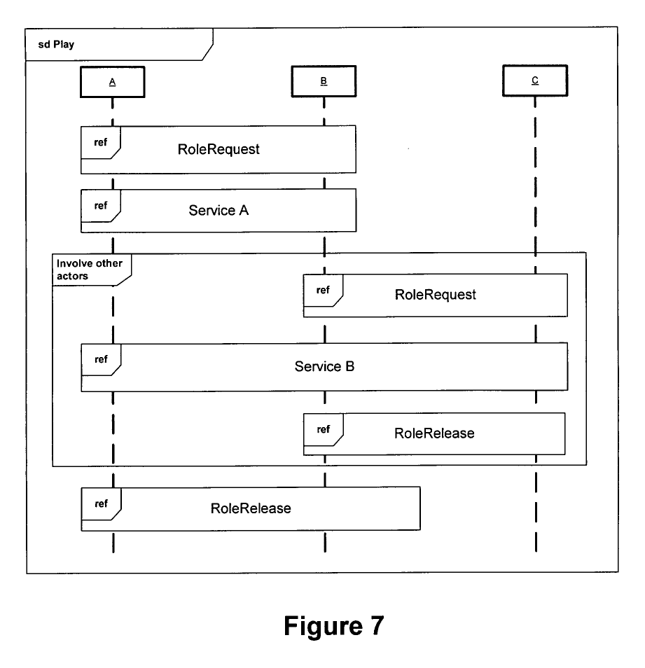

The basic feature of the protocol is to allow an actor (requester) to request another actor to play a specific role and to allow the actors to interact to perform a service or a play. The protocol also includes a protocol to release a requested role. FIG. 7 shows a typical pattern of how RoleRequest and RoleRelease are used to invoke other actors to play services. One RoleRequest may lead to another RoleRequest as shown in the figure. Release of roles may lead to deleting of actors if they play no more roles. It is also possible to define that an actor may exist although it does not play any roles.

### Actor Configuration

The internal structure of all types of actors in a system is defined by associated actor descriptor files. Actor descriptor files have XML format and contains entries for:
Ports and connections
Internal instances (a.k.a. roles, actors, parts) with multiplicities and initial configuration

An Actor xml configuration file contains the following elements:
<description>—description of the actor type
<actortype>—name of actor type
<part>—part specification, the configuration file can contain several part elements
   <parttype>—every part has a type
   <min>—minimum number of instances
   <max>—maximum number of instances
   <instances>—the instance names of the initial parts. If omitted instance names are automatically generated at instantiation time
   <port>—port definitions, a part can have several ports
      <name>—name of the port
      <requestedRole>—the address of the role that the port connects to
      <inquiredRole>—the address of the role that contains the requested role. If omitted the default is the parent actor.

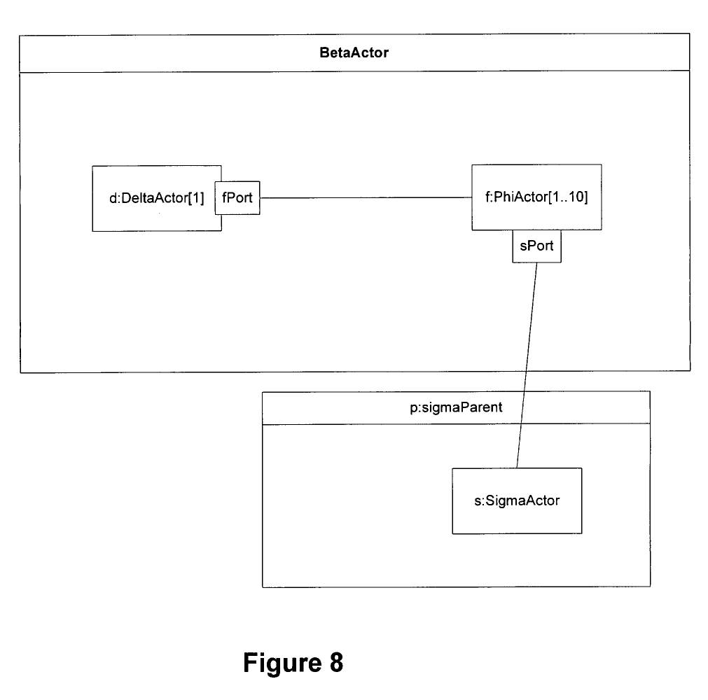

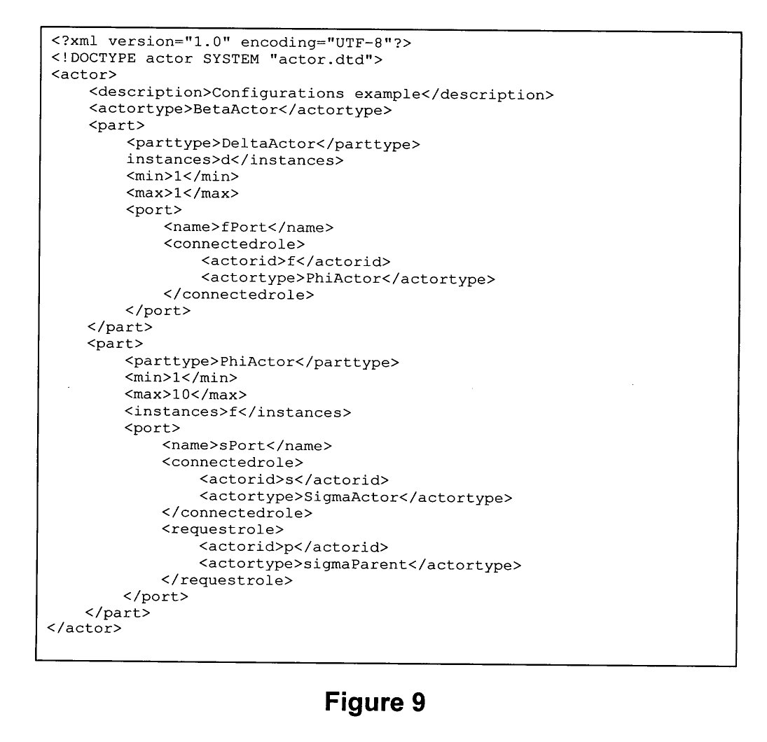

FIG. 8 shows an example of an Actor configuration drawn in a structure diagram. The associated actor description file is shown in FIG. 9.

The two parts d:DeltaActor and f:PhiActor are drawn in FIG. 8 connected with a port fPort from d to f. BetaActor xml configuration file in FIG. 9 contains the corresponding definitions. Two <part> elements are described along with a <port> element directed from part d to part f. The name of the initial part instances are d and f respectively. The <min> and <max> elements define that there can only be one DeltaActor and up to ten PhiActors. The port name is defined in the <name> element below <port> as fPort. Eventually a port and connection is directed out of the enclosing composite from f:PhiActor to s:SigmaActor. Due to the fact that s:SigmaActor is part of another enclosing composite object, the element <requestedrole> is required to define the instance name and type of this encloser.

### Messages

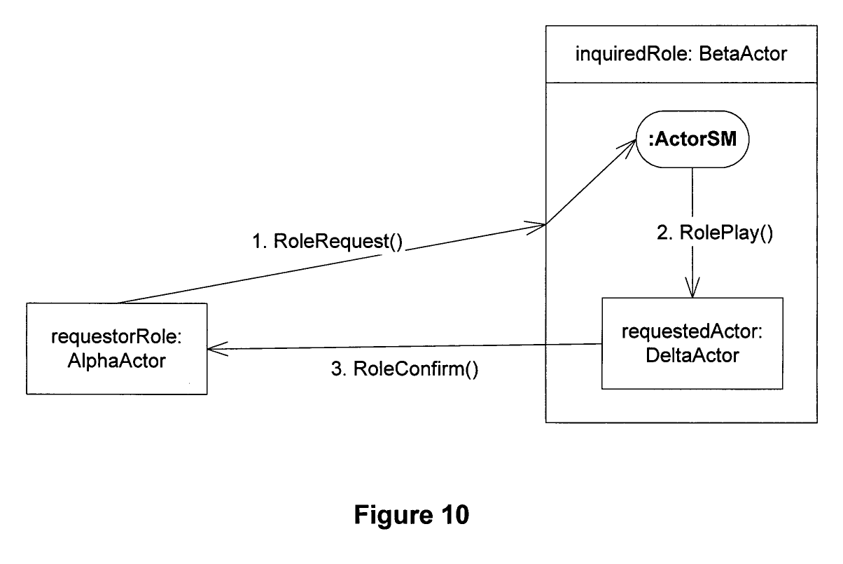

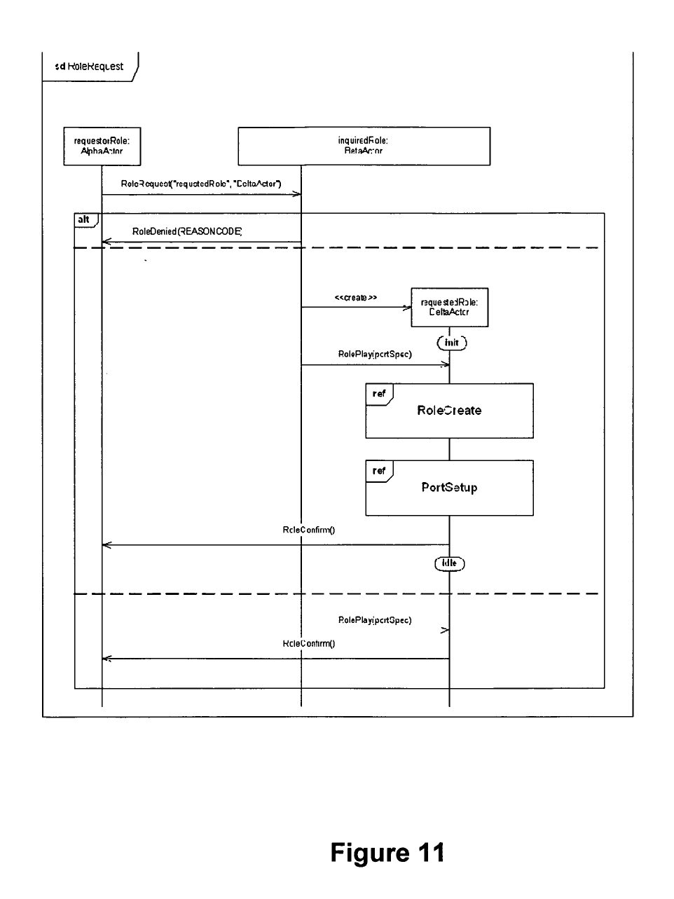

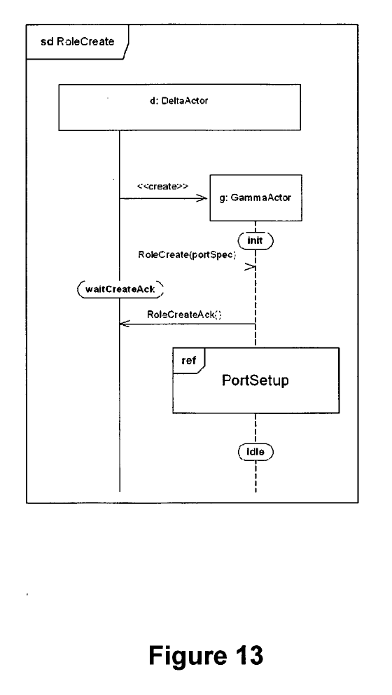

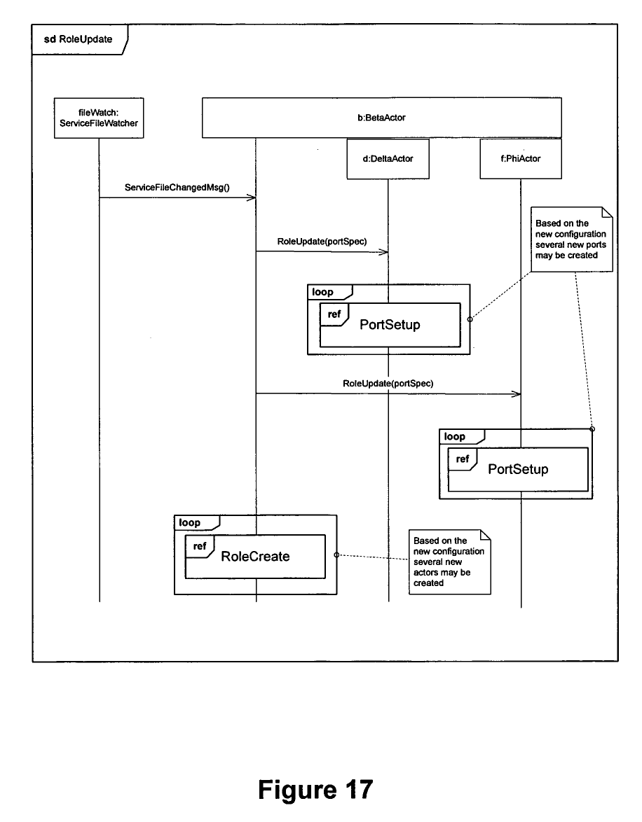

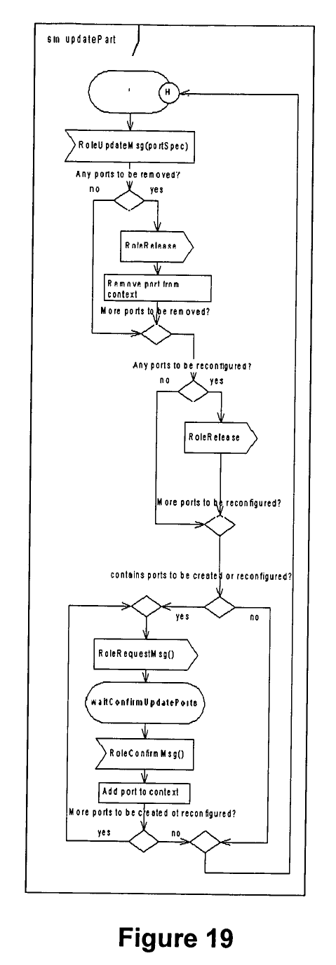

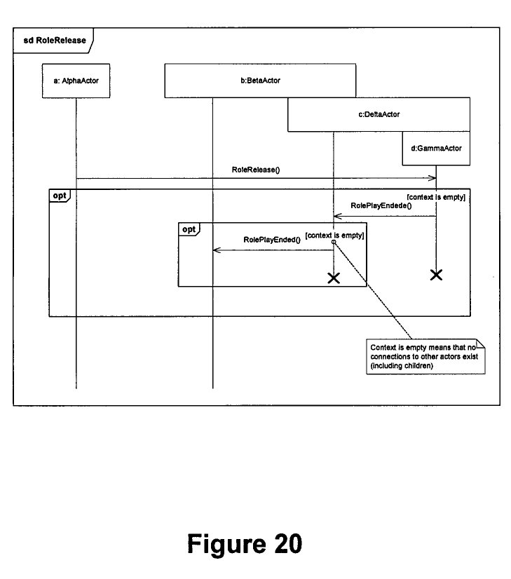

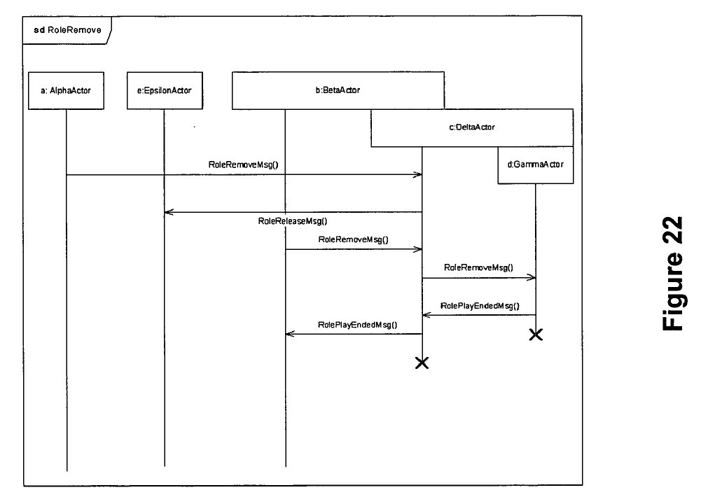

This subsection contains all messages involved in the ActorFrame package.

| | |
|---|---|
| MessageType: | RoleRequestMsg |
| Description: | RoleRequestMsg is sent to an Actor to ask if |
| | the Actor is willing to play a Role (taken |
| | care of by a child/innerActor). |
| Parameters: | java.lang.String roleID - The roleID of the |
| | requested role. If omitted the inquired actor |
| | will assign a random roleID, |
| | java.lang.String roleType - The actor type of |
| | the requested role, |
| | java.io.Serializable credential - The |
| | credentials of the requesting role |
| Usage: | FIG. 10, 11, 12, 14, 15, 16 RoleRequest |

| | |
|---|---|
| MessageType: | RoleConfirmMsg |
| Description: | RoleConfirmMsg is returned to the sender of a |
| | RoleRequestMsg if the Connection is |
| | successfully established. |
| Parameters: | RoleRequestMsg rrm - The original |
| | RoleRequestMessage that led up to this |
| | RoleConfirmMessage |
| Usage: | FIG. 10, 11, 12, 15, 16, 19 RoleRequest |

| | |
|---|---|
| MessageType: | RoleDeniedMsg |
| Description: | RoleDeniedMsg is returned to the sender of a |
| | RoleRequestMsg if the requested Association |
| | is not established. |
| Parameters: | rrm - RoleRequestMessage |
| | roleAlternatives - if alternative roles can |
| | be offered - |
| | or |
| | reasonCode - the reason if the role was |
| | denied |
| Usage: | FIG. 10, 11, 14 RoleRequest |

| | |
|---|---|
| MessageType: | RoleCreateMsg |
| Description: | The receiver of the message creates a new |
| | instance of the actor type. |
| Parameters: | java.util.Vector ports |
| Usage: | FIG. 11, 13, 15, 16, 17, 18 RoleCreate |

| | |
|---|---|
| MessageType: | RoleCreateAckMsg |
| Description: | RoleCreateAckMsg is returned to the sender of |
| | a RoleCreateMsg if the role is successfully |
| | instantiated. |
| Parameters: | |
| Usage: | FIG. 13, 15, 16. RoleCreate |

| | |
|---|---|
| MessageType: | RolePlayMsg |
| Description: | RolePlayMsg is sent from the parent Actor to |
| | a child Role to indicate that the child Role |
| | is to take part in a given Play with a given |
| | requestor. |
| Parameters: | RoleRequestMsg rrm - The original |
| | RoleRequestMessage that led up to this |
| | RoleConfirmMessage, |
| | java.util.Vector ports - ports of the invoked |
| | role |
| Usage: | FIG. 10, 11, 14, 15 RoleRequest |

| | |
|---|---|
| MessageType: | RolePlayEndedMsg |
| Description: | RolePlayEndedMsg is sent to the parent Actor |
| | when a child Role exits the playing state and |
| | enters the idle state. |
| Parameters: | |
| Usage: | FIG. 22, 23 Role Remove, |
| | FIG. 20, 21 Role Release |

| | |
|---|---|
| MessageType: | RoleReleaseMsg |
| Description: | RoleReleaseMsg is sent from one of the Roles |
| | in an Association (requestor or requested) to |
| | the other Role in the Association in order to |
| | remove the Association. |
| Parameters: | |
| Usage: | FIG. 19, 20, 21, 22, 23 Role Release |

| | |
|---|---|
| MessageType: | RoleRemoveMsg |
| Description: | RoleRemoveMsg is sent from an Actor to a Role |
| | to instruct it to commit suicide. |
| Parameters: | |
| Usage: | FIG. 22, 23 Role Remove |

| | |
|---|---|
| MessageType: | RoleUpdateMsg |
| Description: | The receiver of this message performs an |
| | update of all its ports and connections |
| Parameters: | java.util.Vector ports - ports of the invoked |
| | role |
| Usage: | FIG. 17, 18, 19 Role configuration |

| | |
|---|---|
| MessageType: | ServiceFileChangedMsg |
| Description: | The receiver of this message is informed that |
| | its configuration file has changed |
| Parameters: | |
| Usage: | FIG. 17, 18, 19 Role configuration |

### Role Creation

The RoleRequest and RoleCreate protocols constitute the basic interaction patterns between Actors in ActorFrame. They cope with how Actors are created according to initial configuration and during execution.

The communication diagram in FIG. 10 shows the involved parts of the RoleRequest interaction. In the sequence the actor names in FIG. 10 will be referred to.

### RoleRequest

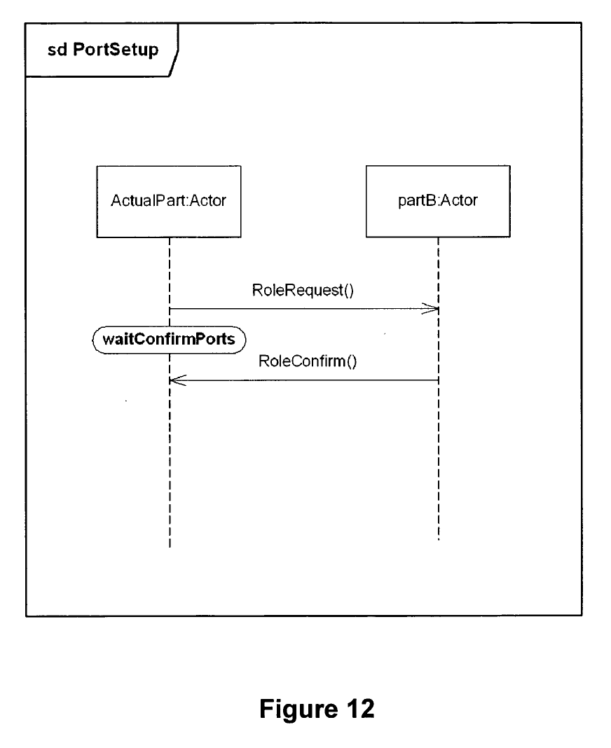

FIG. 11 shows the interplay between actors taking place when a “requester” actor inquires an “inquired” actor to play a “requested” role. Three alternatives are showed in the diagram.
1. The RoleDenied signal indicates that the requested role is not permitted to be created. A code is shipped with the RoleDenied signal indicating the reason. Reasons for disallowing creation of actors are derived from the actor configuration files discussed under the Actor Configuration section above.
2. In case the role request is approved by the “inquired” actor, an actor creation process is initiated. The “requested” role is first instantiated. Further, from its parent actor it receives a RolePlaMsgy signal containing a specification of its initial connections to other actors. Based on the configuration for the “requested” role type a RoleCreate process can be started in order to create its internal structure. The next section RoleCreate will explain this sequence. After the internal structure is established the port connections are set up. This is achieved by using the RoleRequest protocol towards the relevant actors (illustrated in FIG. 12. Eventually a RoleConfirmMsg signal is sent back to the “requestor” confirming that the requested role is playing.
3. In case the “requested” role already exists it will be notified by a RolePlayMsg signal that the “requestor” role will create a connection. Eventually a RoleConfirmMsg signal is sent back to the “requester” confirming that the requested role is playing.

### RoleCreate

The RoleCreate interaction pattern applies when an actor is created that contains inner parts. An actor may either be created at instantiation time of its parent if it is an initial part of the parent actor, or as a result of a role request from another actor.

FIG. 13 illustrates how the actor d:DeltaActor creates the inner part g:GammaActor at creation time. Actor g:GammaActor receives a RoleCreate message containing the port specification. If g:GammaActor contained inner parts it would now initiate the role creation of inner parts. In FIG. 13 g:GammaActor has initially an empty structure and hence a RoleCreateAck is issued back to the parent actor in order to notify that the inner actor is ready.

### Actor State Machines

Recall that all actor types presented so far in this chapter are subtypes of the generic type Actor. When subtypes such as DeltaActor or GammaActor are defined they will inherit behaviour from Actor. In this subsection the state machines related to the role request and role create interaction patterns will be presented. It is important to bear in mind that any parts involved in the interactions are of Actor type. When looking into the state machines different aspects will be involved dependent of whether the actor is an inquired, requested, initial role, etc. In the sequel it will be explicitly mentioned what view that is presented.

### Inquired Role State Machine

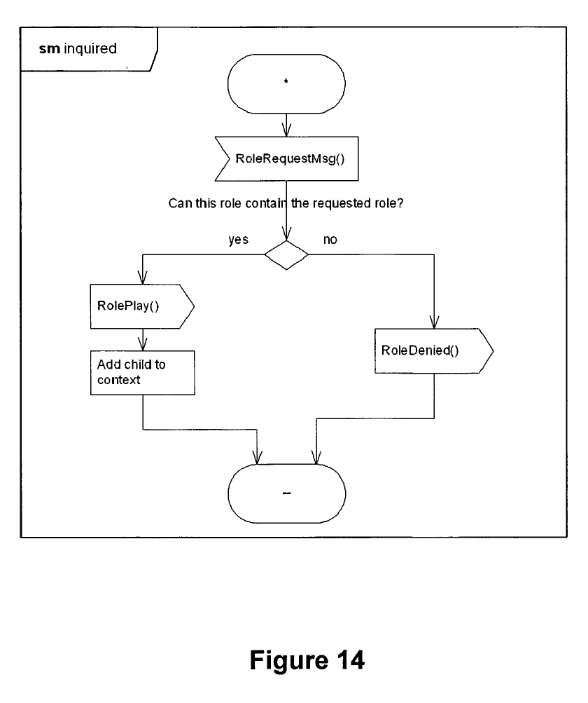

FIG. 14 shows the relevant view of the actor state machine from an inquired role point of sight. The inquired role accepts the RoleRequest message in any state. Then based on its configuration it will either invoke a new role or retrieve an already existing role and pass on a RolePlay signal to the inner role. In case the inquired role cannot contain the inner role asked for a RoleDenied signal will be issued back to the requestor.

### Requested Role State Machine

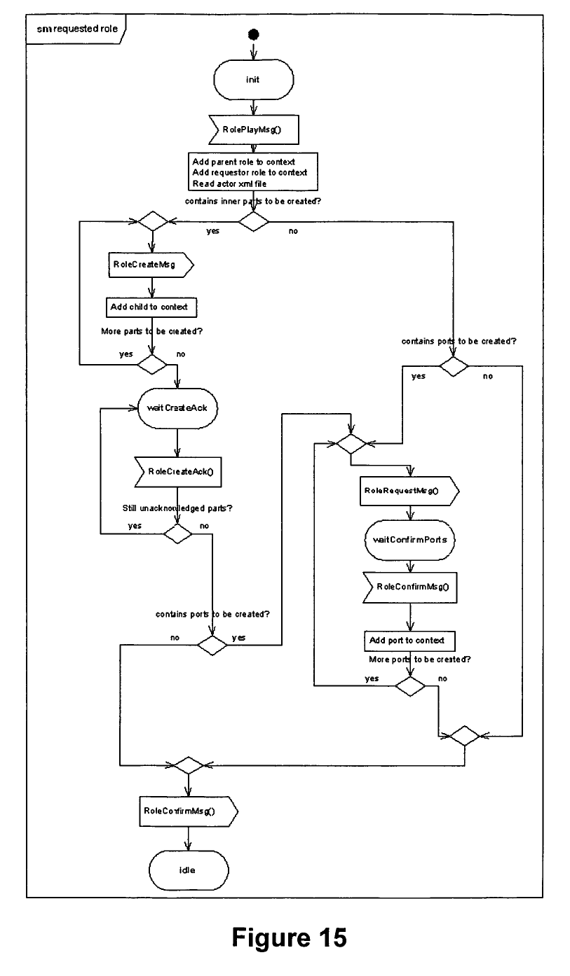

FIG. 15 shows the relevant view of the actor state machine from a requested role point of sight. Initially the state machine will enter state init. It remains there until the RolePlay signal arrives containing the specification of port connections. The actor configuration file is then loaded along with updating the context variable of the actor. If the actor type contains inner parts these are first instantiated. The actor will be in state waitCreateAck as long as new instances are acknowledging successful creation. Further, any defined ports and connections to other actors are set up. The actor will wait in state waitConfirmPort for as long as the port setup process is active. Eventually a RoleConfirm signal is sent back to the requestor role.

### Initial Part State Machine

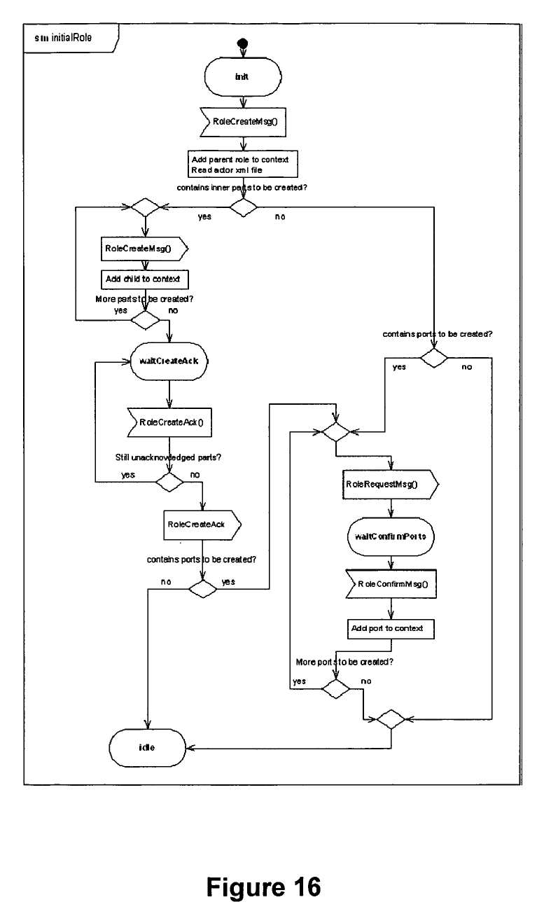

FIG. 16 shows the relevant aspect of the actor state machine when it is instantiated as a result of a configuration where it belongs as an initial part (role). The diagram is very similar to FIG. 15 showing the invoked actor state machine. The only difference is that a RoleCreate signal is received rather than a RolePlay signal. This is to indicate that the role is instantiated on request from the parent actor rather than a requesting actor. Next difference is that the initialRole state machine will issue a RoleCreateAck signal to the parent to indicate that it is successfully instantiated with all inner parts. In the end no RoleConfirm signal is sent since this actor is requested by the parent actor.

### Role Configuration

An actor provides support for a dynamic reconfiguration during execution based on actor xml files. New parts (roles) may be added and multiplicities can be changed. Existing ports can be removed, added or reconfigured to connect to other actors. This section describes the protocols and state machines involved in this action.

### Role Update

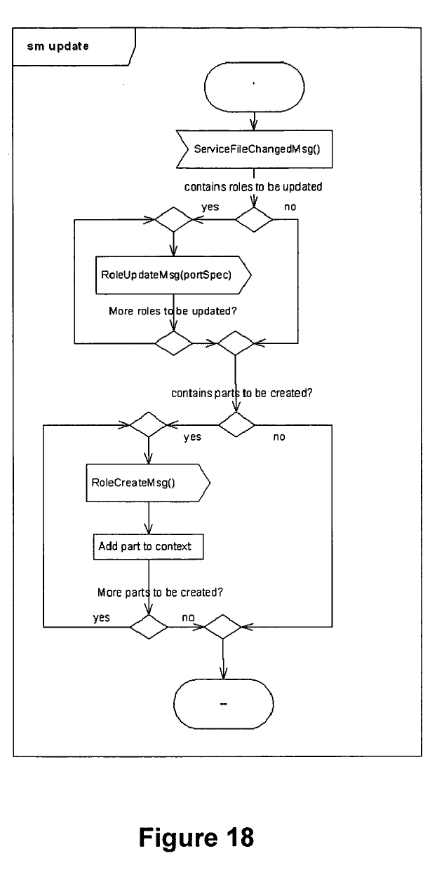

FIG. 17 describes how a change in the xml configuration file is propagated to the relevant actors. The fileWatcher actor defined as part of the ServiceFrame framework, will inform the affected actors that their configuration file has changed. Upon receiving a ServiceFileChangedMsg the actor loads and inspects the new configuration. Any new roles are created, multiplicities are updated and the new port specifications are sent to all children roles of the actor. Every children role will then inspect the new port specification and update its connections accordingly. FIG. 18 and FIG. 19 shows the involved parts of the Actor state machine for the updated actor and the updated parts respectively.

### Role Release

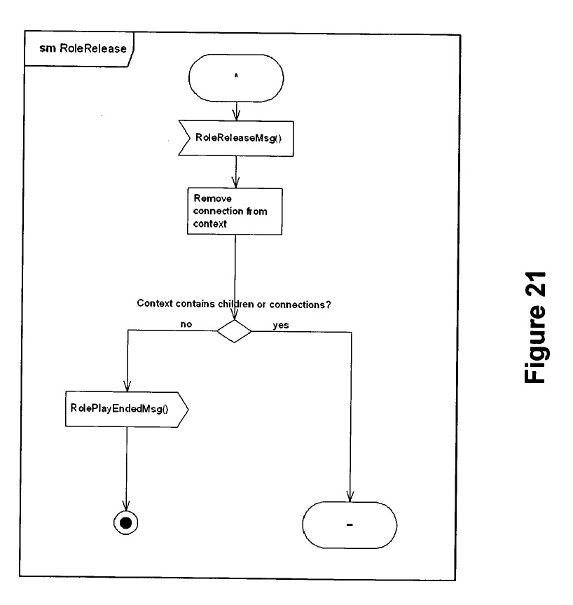

In order to release connections between actors, role release messages are used. Upon receiving a role release message the sender of the message is removed from the actor's context. This is described in FIG. 21. If the context of an actor is empty after a role release and it is not defined as an initial role it will cease to exist. The Actor indicates this to its parent by sending a RolePlayEndedMsg as shown in FIG. 20.

### Role Remove

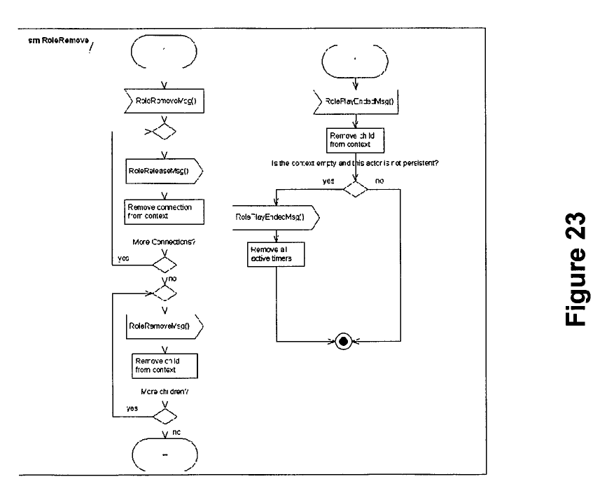

When a RoleRemove message is received the actor prepares for removal by sending out RoleRelease messages to all its connected roles. Further, it sends RoleRemove messages to all its inner actors. When RolePlayEnded messages are received from all its inner actors it will issue a RolePlayEnded message to its parent actor before it ceases to exist. The process is described in FIG. 22. FIG. 23 shows the state machine view of the process.

### ADVANTAGES OF THE INVENTION

This invention provides a solution for changing service configuration without stopping execution of services. This invention also simplifies the process of configuring the components of services with high complexity. The invention also supports reconfiguration of services that are deployed on distributed platforms.

Applications and services have usually required off line changes in the implementation, which have caused unwanted downtime of the services. But this invention specifies a solution that allows the administrators of the service execution platforms to specify changes in the configuration, deploy new services and remove services without changing the actual implementation of the deployed services.

This invention introduces a new protocol for a run time configuration of deployed actors. Complex service components consist of several actors. The structures of the service components are described using configuration files. This makes it possible to dynamically change the structure of applications such as changing versions of components, alter between which components to use, to change number of instances while the services or components are executing. Change in the configuration file is detected and this invention automatically updates the running services although they are running distributed.

Service reconfiguration has not been possible in prior systems without changing the code of services and redeploying the services again. This has resulted in less availability of the services and longer lead-time for implementation of changes.

### Concepts and Abbreviations

### Actor Concepts

Actor An actor is an active class with an own machine state machine and it may contain inner parts. Actors may be requested for playing a specific role.

ActorAddress The address of an actor, which consists of an actor identification represented as a string and an actor type that identifies the class type.

Role A role is an actor that is played by another actor.

RoleType The type identification of a role.

RoleId A name that identifies a specific role of a RoleType

ActorType Similar as RoleType, but denotes an actor

ActorId A name that identifies a specific role of an actorType

Inquired actor An actor that is requested to play a specific role

Requested actor The actor that the inquired actor is requested to play

Requestor actor The actor that makes an request to another actor (inquired actor) to play a specific role.

Actor context The context information of an actor that is specific for each actor instance as references to parent, requested and requestored actors and children or parts instances.

ActorFrame protocol The protocol actors use to invoke other actors and to control the lifecycle of actors.

Role Request A specific message used by the ActorFrame protocol to make requests for role to be played by other actors.

Part Similar to the UML2.0 concept part that represents instances of actors that are part of a containing actor.

Port Similar to the port concept in UML used to connect parts together.

### Abbreviations

| | |
|---|---|
| ACID | Atomicity, Consistency, Isolation and Durability |
| CORBA | Common Object Request Broker Architecture |
| CS | Common Object Request Broker Architecture |
| SM | State Machine |
| EJB | Enterprise Java Beans |
| IIOP | Internet Inter-Orb Protocol |
| J2EE | Java 2 Enterprise Edition |
| J2SE | Java 2 Standard Edition |
| JMS | Java Messaging Service |
| JNDI | Java Naming Directory Interface |
| JVM | Java Virtual Machine |
| MDK | Modelling Development Kit |
| MSC | Message Sequence Chart |
| RMI | Remote Method Invocation |
| RMI/IIOP | Remote Method Invocation over Internet Inter-Orb |
| | Protocol |
| RPC | Remote Procedure Call |
| SDL | Specification and Description Language |
| SOA | Service-Oriented Architecture |
| SOAP | Simple Object Access Protocol |
| UDDI | Universal Description, Discovery, and |
| | Integration |
| UML | Unified Modelling Language |
| UMTS | Universal Mobile Telecommunications System |
| WAP | Wireless Application Protocol |
| WSDL | Web Services Description Language |
| XML | Extensible Markup Language |
| API | Application Programming Interface |
| JAX-RPC | Java XML based Remote Procedure Call |
| MDA | Modelling Driven Approach |
| PIM | Platform Independent Models - used in MDA |
| | terminology |
| PSM | Platform Specific Models - used in MDA |
| | terminology |
| ALIN | Application Layer Internet working |
| MDA | Model Driven Architecture |
| JDBC | Java Data Base Connectivity |
| CMP | Container Managed Persistency |
| BMP | Bean Managed Persistency |
| MOM | Message Oriented Middleware |
| DNS | Domain Name Server |
| JMS | Java Messaging System |

### REFERENCES

1. Bræk, Rolf, Husa, Knut Eilif and Melby, Geir. ServiceFrame Whitepaper, draft 1.9.2001, Ericsson NorARC, 2001.
2. Haugen, Øystein and Møller-Pedersen, Birger. JavaFrame: Framework for Java-enabled modelling, ECSE2000, Ericsson NorARC, Stockholm, 2000.

1-11. (canceled)

12. A method for dynamically deployment and reconfiguration of services such as peer to peer type of services using a protocol suite running on a generic distributed middleware platform, such as ActorFrame characterized in that said method comprise the steps of:
detecting changes in the configuration specification for one or more actors and responding to changes in the configuration specification for the actors with a response sent to affected actors so as to take needed actions according to the changes, and
dynamically and preferably in real time reconfigure the affected actors with reconfigurations as follows:
adding one or more new actors and changing a number of maximum and minimum number of allowed actors and
reconfiguring existing connections between actors.

13. A method according to claim 12, characterized in that the method further comprises the following steps carried out on the protocol suite:
a RoleRequest, is sent to a first Actor requesting the first actor to play a Role such as instantiating an internal instance, and
a RoleRelease, is sent from one of the roles in an association to another role with the objective to remove the association, and
a RoleCreation instantiates a new instance of an Actor type, and
a RoleUpdate instructs a receiver to perform an update of all its ports and connections, and
a RoleRemove instructs an Actor to remove itself.

14. A protocol suite for dynamically deployment and reconfiguration of services such as peer to peer type of services running on a generic distributed middleware platform, such as ActorFrame characterized in that the protocol suite is adapted to:
detect changes in the configuration specification for one or more actors and to respond to changes in the configuration specification for the actors with a response sent to affected actors so as to take needed actions such as add new instances of actors according to the changes, and
the protocol suite is further adapted to dynamically and preferably in real time to reconfigure the affected actors with reconfigurations as follows:
to add new instances of actors and to change number of maximum and minimum number of allowed actors instances, and
to remove or reconfigure existing connections between actors thereby allowing changes of structures (such as) as versions of one or more actor changes in order to add new connections between actors to adapt to new actors.

15. Protocol suite according to claim 14, characterized in that the service arrangement is a peer to peer structure of collaborating actors adapted to achieve a service aim, such as chatting.

16. Protocol suite according to claim 14, characterized by the protocols:
RoleRequest, is sent to an Actor to ask if the Actor is willing to play a Role such as instantiating an internal instance, and
RoleRelease, that is sent from one of the roles in an association to the other role with objective to remove the association, and
RoleCreation, that instantiates a new instance of an Actor type, and
RoleUpdate, that instructs the receiver to perform an o update of all its ports and connections, and
RoleRemove, that instructs an Actor to remove itself.

17. Protocol suite according to claim 16, characterized in that the generic distributed middleware platform is specified in that it s supports distributed actors executing on different nodes, such as Java enabled mobile phones and J2EE platforms.

18. Protocol suite according to claim 16, characterized in that the internal structure of an Actor arrangement is defined by associated o actor descriptor files having XML format and containing entries for:
Ports and connections, and internal instances (roles, actors, parts) with multiplicities and initial configuration.

19. Protocol suite according to claim 18, characterized in that the Actor xml configuration file comprises one or more of the following elements:
<description>—a description of the actor type,
<actortype>—a name of the actor type,
<part>—one or many part elements,
<actordomain>—a domain where the actor will be instantiated,
<parttype>—a type of the part,
<min>—a minimum number of instances,
<max>—a maximum number of instances,

20. Protocol suite according to claim 19, characterized in that one part comprises at least one port.

21. Protocol suite according to claim 18, characterized in that the Actor has behaviour specified by an Actor state machine.

22. Protocol suite according to claim 21, is characterized in that the actor types are subtypes of the generic type Actor and that the subtypes actors such as DeltaActor or GammaActor will inherit behaviour from generic type Actor.
